(19) United States
(12) Patent Application Publication
(10) Pub. No.: US 2023/0278259 A1
(43) Pub. Date: Sep. 7, 2023

(54) CUTTING SEGMENT FOR A SAW BLADE

(71) Applicant: HUSQVARNA AB, Huskvarna (SE)

(72) Inventors: Philippe Uytters, Wezembeek-Oppem (BE); Brianna Welch, Columbia, SC (US); Fredrik Sjödahl, Jönköping (SE); Salvatore Callari, Ressaix (BE)

(21) Appl. No.: 18/018,076

(22) PCT Filed: Aug. 3, 2021
(86) PCT No.: PCT/EP2021/071700

§ 371 Date: Jan. 26, 2023

(30) Foreign Application Priority Data
Aug. 4, 2020 (SE) 2050932-9

(51) Int. Cl. B28D 1/12; B23D 61/18

(52) U.S. Cl. CPC B28D 1/121; B23D 61/18

(57) ABSTRACT

A cutting segment (110) for mounting onto a saw blade to provide an abrasive operation by the saw blade, the cutting segment comprising a body (200) having a cutting surface (210) facing in a cutting direction (C), and side surfaces (220) facing laterally (L) with respect to the cutting direction (C), wherein a plurality of protrusions (230) extend laterally from the sides (220), and wherein the cutting segment (110, 410, 510) constituted by the body (200) and the protrusions (230) is formed by a homogenous mixture of metal powder and diamond granules.

### TECHNICAL FIELD

The present disclosure relates to abrasive cutting tools for processing hard materials such as concrete, reinforced concrete, and stone. There are disclosed cutting segments and saw blades comprising the cutting segments, as well as related work tools and construction equipment.

### BACKGROUND

It is known to use diamond tools for cutting hard materials such as concrete, reinforced concrete and stone. Diamond tools normally use cutting segments arranged on the periphery of a rotatable disc which engages the material to be cut in an abrasive manner.

In order to promote an efficient cutting operation, it is desired to minimize friction on surfaces of the cutting segment which are lateral to the direction of the cut.

During operation dust and/or slurry is generated which needs to be transported away from the cutting area in order to not reduce cutting performance. It is therefore desired to promote evacuation of the dust and/or slurry which is generated during cutting from the cutting area.

US2010291845 discloses a diamond tool where diamond granules are arranged at outer peripheries of cutting segments and placed in a radial pattern from a centre of a shank of the diamond tool, so that a constant cutting force is maintained even though the segments are worn out, and thus, the same cutting force is maintained during the service life of the diamond tool.

US20060130823A1 and in WO2002066217A1 also disclose cutting segments and diamond tools for cutting hard materials such as concrete, reinforced concrete and stone.

However, there is a need for more cost-efficient cutting segments allowing improved cutting action in terms of, e.g., cutting speed and segment lifetime.

### SUMMARY

It is an object of the present disclosure to provide improved cutting segments, saw blades and work tools for cutting hard materials such as reinforced concrete and stone by abrasive operation which alleviate at least some of the above-mentioned issues.

This object is obtained by a cutting segment for mounting onto a saw blade to provide an abrasive operation by the saw blade. The cutting segment comprises a body having a cutting surface facing in a cutting direction of the cutting segment, and side surfaces facing laterally with respect to the cutting direction. A plurality of protrusions extends laterally from the side surfaces. The cutting segment constituted by the body and by the protrusions is formed by a homogenous mixture of metal powder and diamond granules.

Since the whole cutting segment is formed by a single homogenous mixture of metal powder and diamond granules it can be manufactured in an efficient and cost-effective manner, e.g., by cold pressing the cutting segment.

Some of the protrusions may comprise a diamond granule and some protrusions may only comprise metal. However, statistically, a fraction of the protruding elements will comprise diamond granules that will protect the cutting segment from lateral wear. The protrusions extend out laterally from the side surfaces of the cutting segment, which means that the protrusions will make contact in lateral direction with the work object to be cut, and not the side surfaces. This means that the protrusions reduce lateral friction forces acting on the cutting segment and also promote evacuation of dust and slurry from the cutting zone during operation, which is an advantage.

Advantageously, there is no need to attach protrusions such as diamond granules one-by-one to the sides of the cutting segment since the cutting segment is instead formed by a homogenous mixture of metal powder and diamond granules. This means that, statistically, the fraction of diamond granules is the same throughout the cutting segment.

According to some aspects, the mixture of metal powder and diamond granules in the cutting segment comprises between 90% and 97% metal powder and correspondingly between 10% and 3% diamonds by volume. This range of volume proportions has been found to give good results in terms of cutting efficiency and lifetime of the cutting segment.

The protrusions may have different shapes and sizes. For instance, the protrusions may be hemispherically shaped with a base radius between 0.3 mm and 1.0 mm, and preferably about 0.70 mm, and with a height between 0.2 mm and 0.6 mm, and preferably about 0.40 mm. Hemispherical protrusions allow for an efficient manufacturing process of the cutting segment, and at the same time provide an increased cutting efficiency of the cutting segment due to, e.g., reduced lateral friction. The protrusions may also be of other shapes, such as cylinders, beveled cylinders, rectangles, or beveled rectangles. Generally, the protrusions are delimited by boundaries on the side surfaces, such that at least two protrusion boundaries are separated from each other and from the cutting surface by a portion of side surface.

According to some other aspects, the cutting segment comprises a longitudinal wear indicator groove extending in the cutting direction and facing laterally with respect to the cutting direction. This longitudinal wear indicator groove provides a visual indication of the level of longitudinal wear suffered by the cutting segment. An operator can therefore easily detect when it is time to replace the saw blade.

According to some other aspects, the cutting segment comprises a lateral wear indicator groove formed in one or both of the side surfaces and facing laterally with respect to the cutting direction. The lateral depth of this lateral wear indicator groove is indicative of an acceptable lateral wear of the cutting segment. This lateral wear indicator groove provides visual indication of lateral wear. Thus, similar to the longitudinal wear indicator groove, an operator may visually determine the current lateral wear, and thus determine when it is time to replace the saw blade.

According to further aspects, the protrusions are arranged on offset curved lines. This arrangement of protrusions has been found to yield improvements in cutting efficiency. The curved lines may, e.g., be given by circle segments drawn from a circle with a center which has been offset from a longitudinal centrum line of the cutting segment and from a top line of the cutting segment, as will be explained below. This particular arrangement of the protrusions improves cutting efficiency of the cutting segment while still being easy to manufacture.

According to other aspects, a recess is formed with a lateral extension in the cutting surface. This recess has been shown to reduce undercutting effects, which is an advantage.

The object is also obtained by a saw blade comprising a plurality of cutting segments according to the above, arranged along a peripheral edge of the saw blade. This saw blade can be manufactured in a cost efficient manner and provides excellent cutting efficiency in terms of cutting speed. Some aspects of the proposed saw blade offer improvements up to or even in excess of 20% in cutting speed and about 10% increase in cutting segment lifetime compared to some known saw blades.

According to other aspects, the cutting segments arranged along the peripheral edge of the saw blade are of at least two types, where the cutting segments of the at least two types are interleaved along the peripheral edge of the saw blade. By arranging different types of cutting segments along the periphery of the saw blade, the saw blade can be optimized for different types of materials to be cut in a simple and cost efficient manner, since only a few types of cutting segments are required for a wide range of different optim izations.

There are also disclosed herein work tools and construction equipment associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIGS. 1A-B shows an example saw blade comprising cutting segments;

FIGS. 2A-D shows a cutting segment according to a first example;

FIGS. 3A-F schematically illustrates example protrusion shapes;

FIGS. 4A-C shows a cutting segment according to a second example;

FIGS. 5A-C shows a cutting segment according to a third example;

FIGS. 6A-B shows an example saw blade comprising cutting segments;

FIGS. 7A-B shows another example saw blade comprising cutting segments;

FIG. 8 illustrates a layout of protrusions on a cutting segment; and

FIG. 9 illustrates a layout of protrusions on a cutting segment.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims. This applies in particular to the example dimensions of the cutting segments and the saw blades described below.

A homogeneous mixture is herein to be interpreted as a mixture of particles and/or granules that has approximately the same proportions of its components throughout any given sample. It is appreciated that the proportions of particles throughout the mixture may differ slightly due to randomization. A homogenous mixture of metal powder and diamond granules can, for instance, be obtained by adding the metal powder and the diamond granules to a container and then stirring or shaking the mixture until a homogenous mixture is obtained.

Generally herein, dimensions will be given in millimeters (mm). It is appreciated that the measures given are purely by way of example in order to illustrate how the disclosed cutting segments and saw blades may be realized in practice.

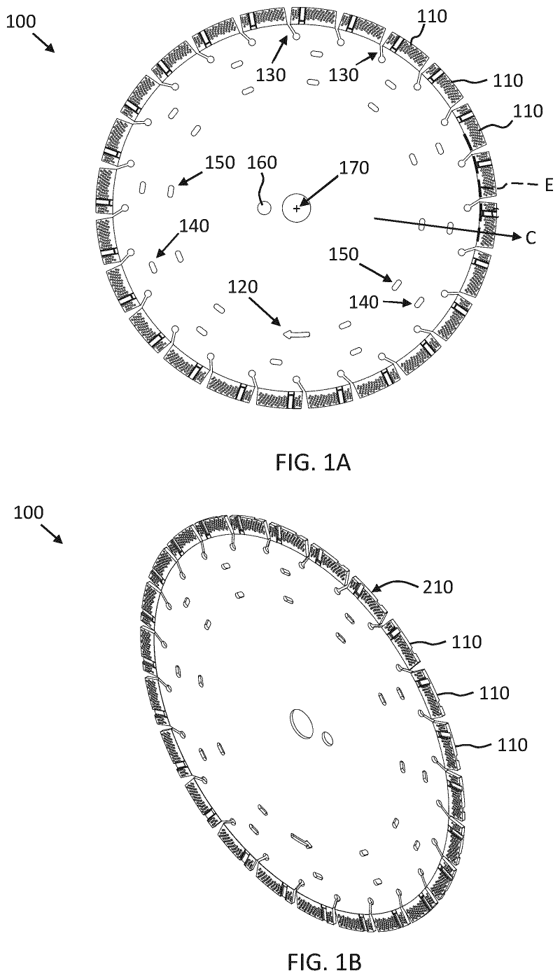

FIGS. 1A and 1B illustrate an example saw blade 100. FIG. 1A shows a front view of the saw blade 100 while FIG. 1B shows a perspective view. The saw blade 100 comprises a number of cutting segments 110 arranged along a peripheral edge E of the saw blade. The radius of the peripheral edge E may be about 130 mm or about 160 mm depending on application, other sizes are of course also possible.

A cutting direction C of the saw blade 100 is a direction extending from the center of the blade towards the peripheral edge E and beyond. This is the direction in which the saw blade engages the material to be cut.

The intended direction of rotation of the saw blade is indicated by an arrow 120, which is optionally cut into the saw blade or otherwise marked on the saw blade.

The cutting segments 110 are separated by inclined slots 130, which are terminated by holes of diameter slightly larger than the width of the inclined slot. These inclined slots promote evacuation of dust and slurry during cutting operation. The inclined slots may have a width of about 2 mm, and an inclination angle of about 30 degrees. These inclined slots promote evacuation of dust and slurry, and also promotes cooling of the cutting segments during cutting operation.

Measuring holes 140 are arranged along a circle centered on the saw blade center 170 and with radius smaller that a radius of the saw blade. The measuring holes allow for measurement of cutting segment wear, e.g., by calipers.

The measuring holes 140, together with a second set of holes 150 also arranged on a circle, form a cutting depth indicator arrangement. The first set of holes 140 may be arranged about 1 inch from the cutting segment edge, and the second set of holes 150 about 2 inches from the cutting segment edge. This way an operator may visually determine approximate cutting depth during operation.

A pin-hole 160 is arranged in connection to the blade center 170 for mounting the blade onto a tool.

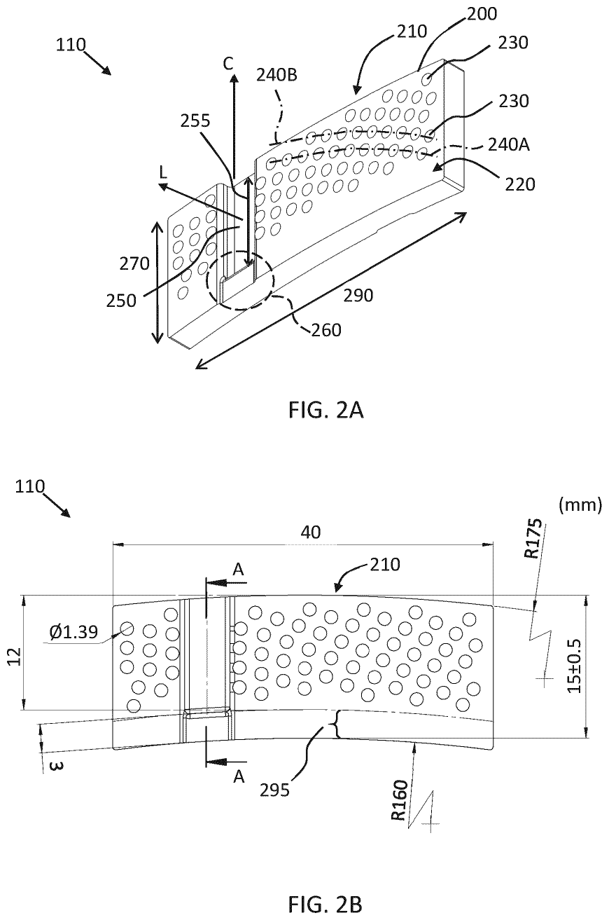

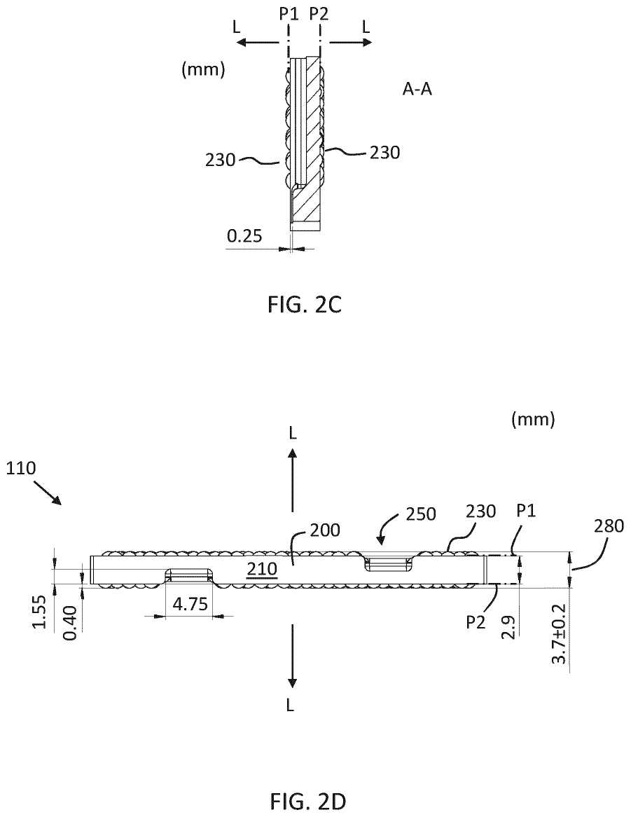

FIGS. 2A-D illustrate an example cutting segment 110 for mounting along the periphery of a saw blade such as the saw blade 100 in FIGS. 1A-B to provide an abrasive operation by the saw blade. The cutting segment comprises a body 200 having a cutting surface 210 facing in a cutting direction C, and side surfaces 220 facing laterally L with respect to the cutting direction C. Notably, a plurality of protrusions 230 extend laterally from the side surfaces 220. These protrusions protect the saw blade from lateral wear, promote evacuation of dust and slurry, and also stabilize the saw blade during the cutting operation. The protrusions have also been shown to result in a reduced lateral friction, which is an advantage. To extend laterally out from the side surfaces means that the protrusions extend laterally beyond a plane P1, P2 of the respective side surface, as shown in FIG. 2C. This is why the protrusions protect the saw blade from lateral wear, and promote evacuation of dust and slurry. A groove formed in the side surface 220 extends in an opposite direction, i.e., into the cutting segment from the side surface. A groove may have some advantageous effects, but will not protect the saw blade from lateral wear, and will not promote evacuation of dust and slurry in the same manner as the protrusions do.

The difference between a groove and a protrusion is clearly seen in FIG. 2D, where the example protrusions 230 extend laterally outwards from respective planes P1, P2, and the example groove 250 extends inwards into the cutting segment body 200.

The cutting segment 110, constituted by the body 200 and by the protrusions 230, is formed by a homogenous mixture of metal powder and diamond granules. That is to say, the protrusions are not attached one-by-one to the body, but rather integrally formed in one piece together with the body. Thus, since the whole cutting segment is formed by a single homogenous mixture of metal powder and diamond granules it can be manufactured in an efficient and cost-effective manner, e.g., by cold pressing the cutting segment. Some of the protrusions may after manufacturing by chance comprise one or more diamond granules and some protrusions may only comprise metal. However, statistically, a fraction of the protruding elements will comprise diamond granules that protect the cutting segment from lateral wear. According to some aspects the size of the diamond granules is selected to be on the order of the size of the protrusions, but not larger than the protrusions since then no diamond granules will protrude from the body 200.

By laboratory experiments, it has been found that a mixture of metal powder and diamond granules comprising between 90% and 97% metal powder and correspondingly between 10% and 3% diamonds by volume is desired in order to provide an efficient cutting operation in a wide range of materials, such as reinforced concrete and stone.

FIGS. 2B, 2C, and 2D show some example dimensions of an example cutting segment. These measures are given purely by way of example and are in no way intended to limit the disclosure. FIG. 2B shows a front view of the cutting segment, with a cut-out view in FIG. 2C, and FIG. 2D shows a top view.

With reference to FIG. 2B, the cutting segment may comprise a bottom backing portion 295 without protrusions extending about 3 mm from the bottom edge (opposite to the cutting edge 210). This bottom backing portion is used to attach the cutting segment to the saw blade core, e.g., by welding. The cutting segment body height including the bottom backing portion 295 is about 15 mm in FIG. 2B. For example, the cutting segment body height may be configured between 14 mm and 20 mm, and preferably either 15 mm or 19 mm. The cutting segment body width 280 may be between 3.5 mm and 4.0 mm, and preferably 3.7 mm, as shown in FIG. 2D. The cutting segment body length 290 may be somewhere between 38 mm and 42 mm, and preferably 40 mm.

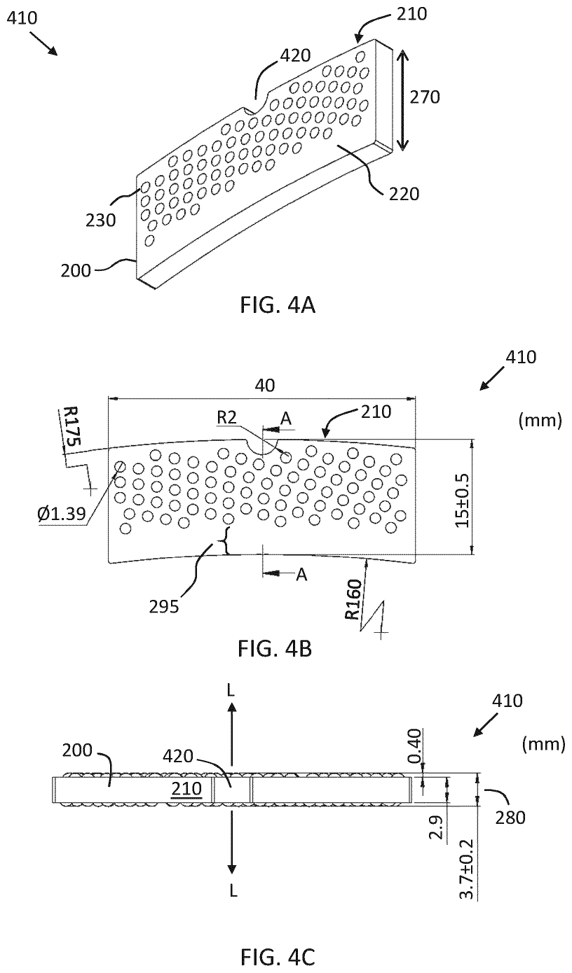

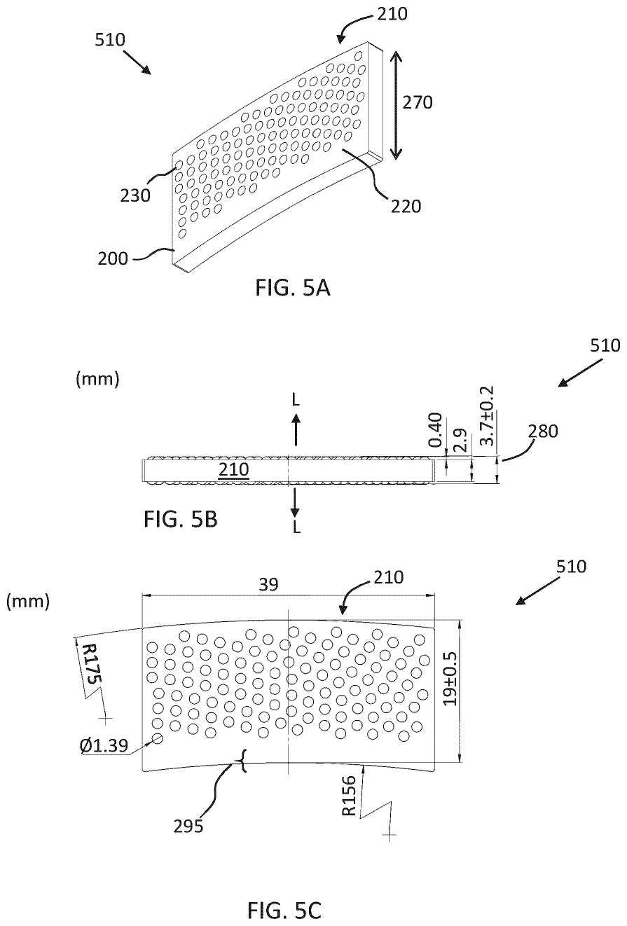

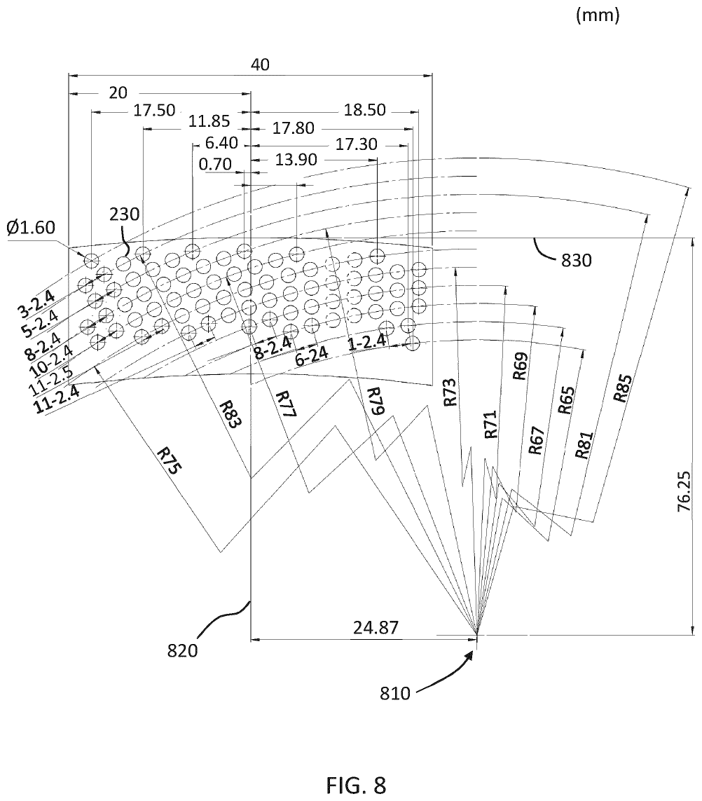

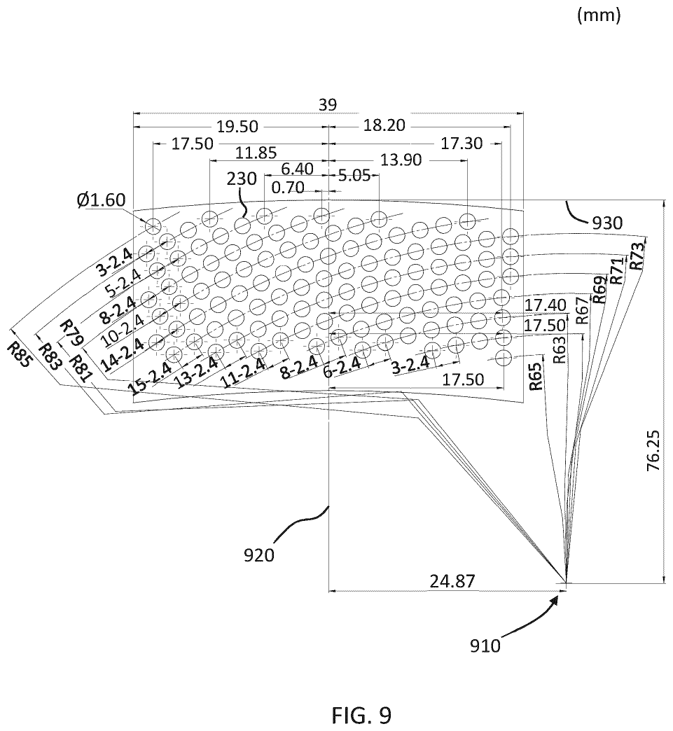

According to some aspects, the protrusions 230 are arranged on offset curved lines 240A, 240B, schematically indicated in FIG. 2A. FIGS. 8 and 9 show these curved lines in more detail and gives some example measures. FIG. 8 illustrates an example layout suitable for the cutting segment 110 or 410 which will be discussed below in connection to FIGS. 4A-C, while FIG. 9 illustrates an example layout suitable for the cutting segment 510 which will be discussed in more detail below in connection to FIGS. 5A-C. Note how the curved lines are defined by circle segments centered at a point 810, 910 offset from the cutting segment side surface center line 820, 920 and top 830, 930.

The cutting segment 110 optionally also comprises a longitudinal wear indicator groove 250 extending in the cutting direction C and facing laterally L with respect to the cutting direction C. A cross-sectional view taken through this longitudinal wear indicator is shown in FIG. 2C (see FIG. 2B). This longitudinal wear indicator groove provides a visual indication of the level of longitudinal wear suffered by the cutting segment. An operator can therefore easily detect visually when it is time to replace the saw blade. Also, by designing the wear indicator to have different extension lengths, different wear limits can be indicated on different cutting segments, as some cutting segments may be more sensitive to longitudinal wear than others. According to an example, the longitudinal wear indicator may be configured to extend from the backing portion 295 and up to the cutting surface 210 when the cutting segment is new.

The combination of the longitudinal wear indicator groove and the protrusions has been found to yield a particularly effective cutting segment.

The cutting segment 110 optionally also comprises a lateral wear indicator groove 260 formed in one or both of the side surfaces 220 and facing laterally L with respect to the cutting direction C. A lateral depth of the lateral wear indicator groove 260 is indicative of an acceptable lateral wear of the cutting segment 110 and can be configured by the designer of the saw blade according to the type of cutting segment and intended use. Thus, an operator may visually determine the current lateral wear, and thus determine when it is time to replace the saw blade.

The combination of the lateral wear indicator groove and the protrusions has been found to yield a particularly effective cutting segment.

Both the longitudinal and the lateral wear indicator also facilitate evacuation of dust and slurry from the cutting zone, by transporting dust and slurry out and away from the cut as the saw blade rotates.

The lateral depth of the lateral wear indicator groove 260 may be on the order of between 0.3 mm and 0.7 mm, and preferably about 0.5 mm.

The height and width of the lateral wear indicator groove 260 may be configured between 2 mm and 4 mm and 3.5 mm and 5.5 mm, and preferably 3 mm and 4.75 mm, respectively.

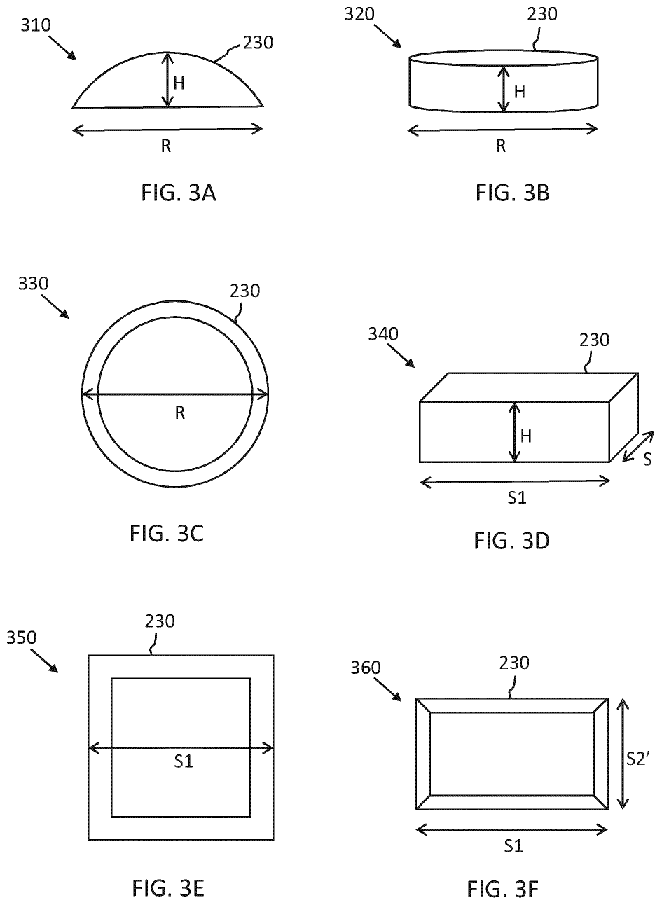

It is appreciated that the protrusions 230 may be formed with different geometrical shapes. FIGS. 3A-F gives some examples of such shapes. The protrusions 230 may be hemispherically shaped 310 with a base radius R between 0.3 mm and 1.0 mm, and preferably about 0.70 mm, and with a height H between 0.2 mm and 0.6 mm, and preferably about 0.40 mm. The protrusions may also be shaped as any of cylinders 320, beveled cylinders 330 (a top view of which is shown in FIG. 3C), rectangles 340 with sides S1 and S2, or beveled rectangles 350, 360. Other example protrusion shapes comprise shapes with a rounded base extending laterally from the side surface.

It is appreciated that a protrusion differs from a groove formed in the side surface. While a protrusion extends laterally out from the side surface, a groove extends laterally inwards towards a center of the cutting segment. As exemplified in FIG. 2C and FIG. 2D, the protrusions 230 extend out from side surface planes P1, P2, in the lateral direction L, while a groove 250 extends into the cutting segment body 200. The side surface plane P1, P2 is a plane aligned with the side surface 220. This feature separates the cutting segments from the generally known turbo type of cutting segments shown in, e.g., US20060130823A1 and in WO2002066217A1.

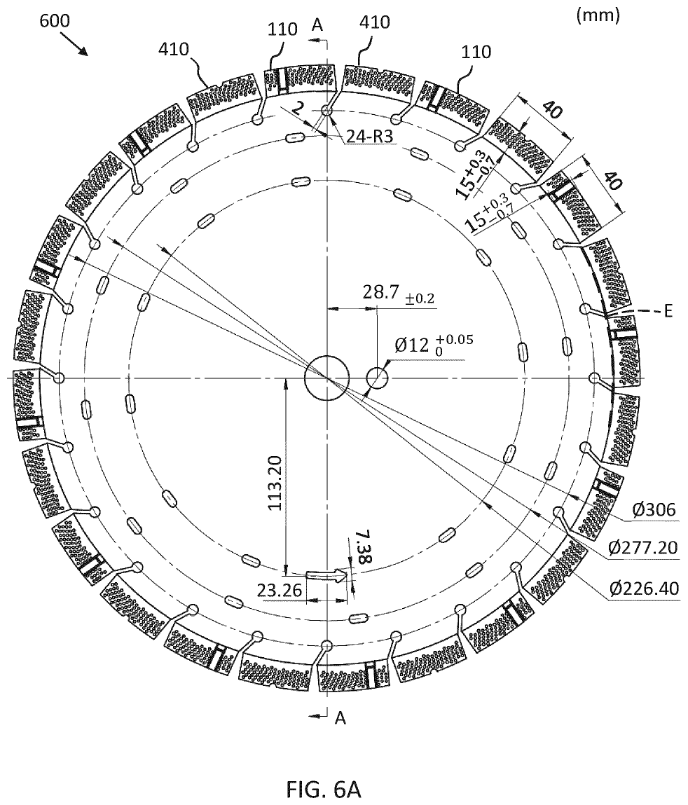

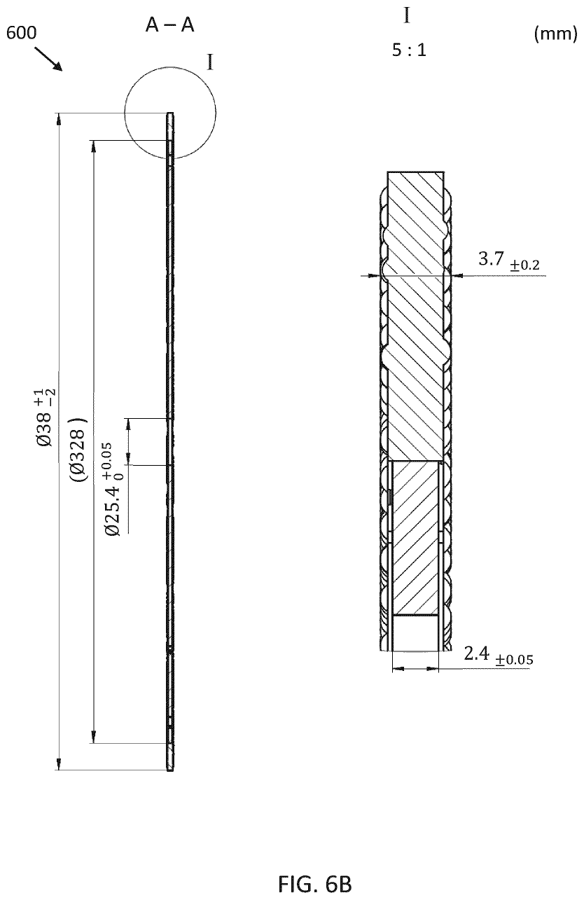

The cutting segment body width 280 may be between 3.5 mm and 4.0 mm, and preferably 3.7 mm, as shown in FIG. 2D. The width of the saw blade core is about 2.4 mm as shown, e.g., in FIG. 6B. Thus, a protrusion extending laterally from the side surface of the cutting segment also extends beyond the side surface of the saw blade core, i.e., the protrusions extend laterally beyond the saw blade disc.

A protrusion is also localized on the side surface, whereas a groove is elongated and has an extension direction along which it extends. According to some aspects, the protrusions discussed herein are confined by a respective protrusion boundary within an area on the side surface of between 0.28 mm² and 3.14 mm² for the round protrusions, which, according to some aspects, also hold true for other shapes of protrusions. The protrusions are delimited by protrusion boundaries on the side surface planes P1, P2, and the boundaries are separated from the cutting surface 210 by a distance. In other words, there is a portion of side surface 220 in-between at least two protrusions 230, and preferably in-between any two protrusions, or at least in-between a majority of the protrusions.

Generally, a protrusion, regardless of its geometrical shape, is confined within a surface area on the side surface of between 0.28 mm² and 3.14 mm². This means that the sides S1 and S2 are on the order of twice the radius R, as illustrated in FIGS. 3A-3F, i.e., between 0.6 mm and 2.0 mm, and preferably about 1.4 mm.

The cutting segments disclosed herein comprise a cutting surface 210. This cutting surface is associated with a normal vector, which, in the example of FIG. 1A extends in direction from the cutting surface to the saw blade center 170. A protrusion generally has a limited extension along a vector normal to the cutting surface, i.e., it does not extend from the cutting surface all the way down to the opposite end of the cutting segment. For example, the protrusions illustrated in FIG. 2B has an extension along the vector normal to the cutting surface 210 of 1.39 mm, which is significantly smaller than the entire extension of the cutting segment along the vector normal to the cutting surface 210, which in FIG. 2B is 12 mm.

The protrusions 230 may, as noted above, be formed with different geometrical shapes. Each such shape is associated with a geometric center, or centroid, i.e., an arithmetic mean position of all the points in the shape. In the cutting segments disclosed herein, as exemplified by, e.g., FIG. 2A, a plurality of protrusions 230 are distributed over the side surface 220 and extend laterally from the side surface of the cutting segment. This means that there are at least two protrusions having geometric centers at different distances from the cutting surface 210. FIGS. 4A-C show another example cutting segment according to the present teaching. This cutting segment does not comprise the longitudinal nor the lateral wear indicator (although these indicators can be included here as well). The cutting segment 410 comprises a recess 420 is formed with lateral extension in the cutting surface 210. Abrasive materials tend to erode the metal core, or center, of diamond cutting blades such as the saw blade 100 shown in FIG. 1A. This effect may lead to so-called undercutting. Undercutting happens when a blade core wears faster than its diamond coating. As an abrasive slurry accumulates, it erodes the steel disc. Found mostly on diamond blades used in asphalt and/or concrete cutting applications, the industrial-grade gems, tough though they are, are left without anything to hold onto when the metal core is worn away. If undercutting is excessive, it can cause segment loss and damage to the blade.

The recess 420 has been shown to reduce such undercutting effects, which is an advantage.

FIG. 4B shows a front view of this cutting segment example 410, while FIG. 4C shows a top view.

FIGS. 5A-C illustrate yet another example cutting segment according to the present teaching. FIG. 5B shows a top view while FIG. 5C shows a front view. This cutting segment has an extended height 270 compared to previously discussed cutting segments 110, 410. According to the example shown in FIG. 5C, this extended height is about 19 mm, including the backing portion. Thus, this cutting segment 510 extends about 4 mm beyond the cutting segments 110, 410 longitudinally.

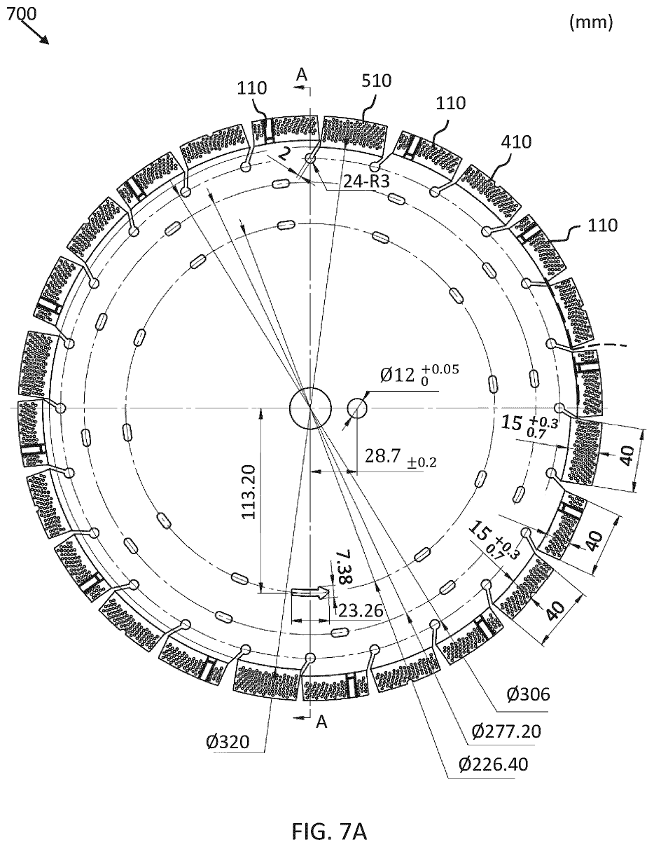

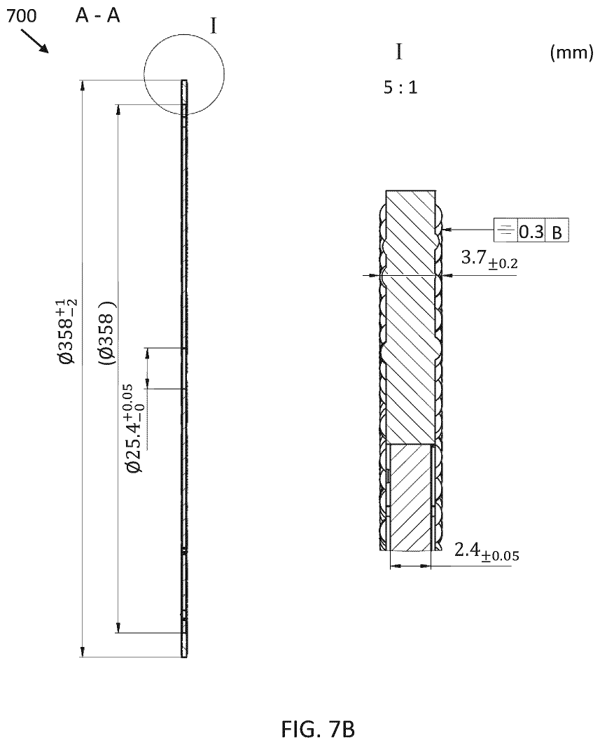

FIGS. 6A-B and FIGS. 7A-B illustrate example saw blades 600, 700, wherein the cutting segments arranged along the peripheral edge E of the saw blade are of at least two types, wherein cutting segments of the at least two types are interleaved along the peripheral edge E of the saw blade. By interleaving different types of cutting elements, a saw blade can be optimized for different materials, and other operation parameters such as rotation speed and cutting speed (applied pressure). For instance, a first type of cutting segment 110 may comprise the longitudinal wear indicator groove 250 extending in the cutting direction C of the saw blade and facing laterally L with respect to the cutting direction C. A second type of cutting segment 410 may comprise the recess 420 formed in the cutting surface 210, as shown in FIGS. 6A-B where cutting segments of the first and of the second type have been interleaved. FIG. 6B shows a side view of the saw blade 600, with an enlargement I taken along cross-section A-A.

A third type of cutting segment 510 optionally has a height 270 larger than at least one other cutting segment on the saw blade 700 as shown in FIG. 7A, where four cutting segments of increased height have been interleaved with other types of cutting segments. This saw blade 700 comprises cutting segments 110 of the first type interleaved with cutting segments of the second type 410, where cutting segments of the third type has been inserted every sixth cutting segment, as shown in FIG. 7A.

FIG. 7B shows a side view with an enlarged cross-section view of the saw blade 700.

1. A cutting segment for mounting onto a saw blade to provide an abrasive operation by the saw blade,
the cutting segment comprising a body having a cutting surface facing in a cutting direction, and side surfaces facing laterally with respect to the cutting direction,
wherein a plurality of protrusions extend laterally from the side surfaces, and
wherein the cutting segment constituted by the body and the protrusions is formed by a homogenous mixture of metal powder and diamond granules.

2. The cutting segment according to claim 1, wherein the mixture of metal powder and diamond granules comprises between 90% and 97% metal powder and correspondingly between 10% and 3% diamonds by volume.

3. The cutting segment according to claim 1, wherein a body height of the cutting segment is between 14 mm and 20 mm,
wherein a body width of the cutting segment is between 3.5 mm and 4.0 mm, or
wherein a body length of the cutting segment is between 38 mm and 42 mm.

4. (canceled)

5. (canceled)

6. The cutting segment according to claim 1, wherein the protrusions are hemispherically shaped with a base radius between 0.3 mm and 1.0 mm, and with a height between 0.2 mm and 0.6 mm.

7. The cutting segment according to claim 1, wherein one or more of the protrusions are shaped as any of cylinders, beveled cylinders, rectangles, or beveled rectangles.

8. The cutting segment according to claim 1, comprising a longitudinal wear indicator groove extending in the cutting direction and facing laterally respect to the cutting direction.

9. The cutting segment according to claim 1, comprising a lateral wear indicator groove formed in one or both of the side surfaces and facing laterally with respect to the cutting direction, wherein a lateral depth of the lateral wear indicator groove is indicative of an acceptable lateral wear of the cutting segment.

10. The cutting segment according to claim 9, wherein the lateral depth of the lateral wear indicator groove is between 0.3 mm and 0.7 mm; or
wherein a height and a width of the lateral wear indicator groove is between 2 mm and 4 mm and 3.5 mm and 5.5 mm, respectively.

11. (canceled)

12. The cutting segment according to claim 1, wherein the protrusions are arranged on offset curved lines, or
wherein a recess is formed with lateral extension in the cutting surface.

13. (canceled)

14. The cutting segment according to claim 1, wherein a first fraction of the protrusions comprises at least one respective diamond granule and wherein a second fraction of the protrusions does not comprise any diamond granule.

15. The cutting segment according to claim 1, wherein the protrusions are arranged to promote evacuation of dust and slurry from a cutting zone of the cutting segment during operation, or
wherein the protrusions are configured to have different shapes and sizes, and/or to have different geometrical shapes.

16. (canceled)

17. The cutting segment according to claim 1, wherein the protrusions are configured with a base radius between 0.3 mm and 1.0 mm, and
wherein at least one of the protrusions are located within an area on a respective side surface of between 0.28 mm² and 3.14 mm².

18. (canceled)

19. The cutting segment according to claim 1, wherein the protrusions are delimited by respective protrusion boundaries on the side surface planes, wherein the boundaries are separated from the cutting surface by a distance, and wherein there is a portion of side surface in between at least two protrusion boundaries.

20. The cutting segment according to claim 1, wherein a size of the diamond granules is selected to be on the order of the size of the protrusions, or
wherein a size of the diamond granules is selected to be smaller than the protrusions.

21. (canceled)

22. The cutting segment according to claim 1, wherein the side surfaces extend along respective side surface planes, wherein the protrusions extend out from the side surface planes in a lateral direction away from the cutting segment, and
wherein at least one of the protrusions) is arranged to extend laterally beyond the saw blade.

23. (canceled)

24. The cutting segment according to claim 1, wherein the cutting surface is associated with a normal vector extending normal to the cutting surface opposite to the cutting direction of the cutting segment, where at least one of the protrusions has a limited extension along the normal vector of the cutting surface.

25. A saw blade comprising a plurality of instances of the cutting segments according to claim 1, wherein each of the plurality of instances of the cutting segment is arranged along a peripheral edge of the saw blade.

26. The saw blade according to claim 25, wherein the cutting segments arranged along the peripheral edge of the saw blade are of at least two types, wherein cutting segments of the at least two types are interleaved along the peripheral edge of the saw blade.

27. The saw blade according to claim 26, wherein a first type of cutting segment comprises the longitudinal wear indicator groove extending in the cutting direction of the saw blade and facing laterally with respect to the cutting direction.

28. The saw blade according to claim 27, wherein a second type of cutting segment comprises a recess formed with lateral extension in the cutting surface, and
wherein a third type of cutting segment has a height larger than at least one other cutting segment on the saw blade.

29. (canceled)

30. (canceled)
